(19) United States
(12) Patent Application Publication
(10) Pub. No.: US 2026/0357803 A1
(43) Pub. Date: Nov. 12, 2026

(54) Integrated Hydraulic Pump-Manifold Assembly

(71) Applicant: Parker-Hannifin Corporation, Cleveland, OH (US)

(72) Inventors: James R. Wheeler, McHenry, IL (US); Bruce J. Besch, Andover, MN (US)

(21) Appl. No.: 19/139,615

(22) PCT Filed: Nov. 27, 2023
(86) PCT No.: PCT/US2023/081063

§ 371 Date: Jun. 16, 2025

Related U.S. Application Data
(60) Provisional application No. 63/478,378, filed on Jan. 4, 2023.
(60) Provisional application No. 63/495,571, filed on Apr. 12, 2023.

(51) Int. Cl. F04C 15/06; F04C 2/18; F15B 15/18; F15B 15/26

(52) U.S. Cl. CPC F04C 15/06; F04C 2/18; F15B 15/18; F15B 15/26; F15B 2211/20515; F15B 2211/62

(57) ABSTRACT

An example integrated pump-manifold assembly includes: a manifold having a pump cavity; a pump disposed in the pump cavity of the manifold, wherein the manifold defines an inlet port and an out let port of the pump; and an adjustable backing plate disposed within the manifold and secured against the pump, wherein the adjustable backing plate is movable within the manifold to allow for pumps of various sizes to be accommodated within the manifold without affecting a size of the integrated pump-manifold assembly.

### CROSS REFERENCE TO RELATED APPLICATION

The present application claims priority to U.S. Provisional Patent Application No. 63/478,378, filed on Jan. 4, 2023, and U.S. Provisional Patent Application No. 63/495,571, filed on Apr. 12, 2023, the entire contents of all of which are herein incorporated by reference as if fully set forth in this description.

### FIELD OF THE INVENTION

The disclosure relates generally to electro-hydraulic pumps (EHPs) and electro-hydraulic actuators (EHAs). More specifically this disclosure relates to an integrated pump-manifold assembly used for EHP and EHA configurations.

### BACKGROUND

FIG. 1 illustrates a perspective view of a pump-manifold assembly 10 mounted to an EHA 12, and FIG. 2 illustrates a perspective view of the pump-manifold assembly 10 of FIG. 1. As shown, a pump 14 is mounted (e.g., via bolts) to a manifold 16. In such configuration, pressurized fluid from the pump 14 is delivered directly to the manifold 16 without the use of hoses or fittings. The manifold 16 may include accessories such as cartridge valves, relief valves, and filters to create a compact hydraulic system. The pump 14 and manifold 16 can be used to control motion (e.g., speed, direction, and force) of a piston of a hydraulic cylinder of the EHA 12, for example.

FIG. 3 illustrates a partial perspective view of the pump-manifold assembly 10 of FIG. 1. Particularly, FIG. 3 depicts a transparent view of the pump 14 and the manifold 16 to illustrate inlet and outlet ports 18 of the pump 14. The EHP and EHA configurations that use such pump-manifold configuration as the pump-manifold assembly 10 can be limited in performance due to the size restriction of the ports 18.

Particularly, the ports 18 are in-line with the pump 14, and thus the ports 18 are limited in size due to the geometry constraints of the pump housing relative to the face of the manifold 16 to which the pump 14 is mounted. This size limitation can cause the pump inlet conditions to drift outside the allowable operating range and prevent the pump 14 from reaching optimal performance. Further, the limited size of the ports 18 can cause cavitation if the pump 14 is operated at a speed that exceeds a threshold speed, thus limiting the flow rate capacity of the pump 14. To alleviate such issues, external pump connections (e.g., external hoses or pipes) may be used.

FIG. 4 illustrates a system 20 having an electric motor 22 driving a pump 24 mounted externally to a manifold 26 and connected to the manifold 26 via external fluid lines. The system 20 can also include an accumulator 28 connected to the manifold 26. The pump 24 and accumulator 28 can provide fluid through the manifold 26 to drive an EHA 30.

In this configuration the pump 24 can be connected to the manifold 26 using standard external hose assemblies or pipes such as pipe 32 and pipe 34 that connect ports such as port 36 of the pump 24 to the manifold 26. However, these additional external connections provide possible leak points and increase the size of the system 20.

Another characteristic of existing EHP and EHA systems is that the physical size of the system increases as pump displacement increases. This is due to the pump being mounted externally onto the manifold (e.g., the pump 14 mounted externally to the manifold 16, and the pump 24 mounted externally to the manifold 26).

FIG. 5 illustrates a side view of an assembly 38 of a first pump 40 mounted to a manifold 42, and FIG. 6 illustrates a side view of an assembly 44 of a second pump 46 mounted to the manifold 42. The second pump 46 has a larger displacement than the first pump 40, and is thus larger than the first pump 40. For example, the first pump 40 may have a 2 cubic centimeter (cc) displacement, whereas the second pump 46 may have a 10 cc displacement. In this example, the assembly 44 having the second pump 46 may have a length L2 that is about 13% longer than a length L1 of the assembly 38 having the first pump 40 due to the larger displacement and size of the second pump 46. Thus, as the pump displacement increases, the overall length of the pump and manifold assembly increases, which might not be desirable.

It is with respect to these and other considerations that the disclosure made herein is presented.

### SUMMARY OF THE INVENTION

The present disclosure describes implementations that relate to an Integrated Hydraulic Pump-Manifold Assembly.

In an example implementation, the present disclosure describes an integrated pump-manifold assembly that includes: a manifold having a pump cavity; a pump disposed in the pump cavity of the manifold, wherein the manifold defines an inlet port and an outlet port of the pump; and an adjustable backing plate disposed within the manifold and secured against the pump, wherein the adjustable backing plate is movable within the manifold to allow for pumps of various displacements to be accommodated within the manifold without affecting a size of the integrated pump-manifold assembly.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 illustrates a perspective view of a pump-manifold configuration mounted to an electro-hydraulic actuator, in accordance with an example.

FIG. 2 illustrates a perspective view of the pump-manifold configuration of FIG. 1, in accordance with an example.

FIG. 3 illustrates a partial perspective view of the pump-manifold configuration mounted to the electro-hydraulic actuator of FIG. 1, in accordance with an example.

FIG. 4 illustrates a system having an electric motor driving a pump mounted externally to a manifold and connected to the manifold via external fluid lines, in accordance with an example.

FIG. 5 illustrates a side view of an assembly of a first pump mounted to a manifold, in accordance with an example.

FIG. 6 illustrates a side view of an assembly of a second pump mounted to the manifold, in accordance with an example.

FIG. 7 illustrates a perspective view of an electrohydraulic actuator, in accordance with an example implementation.

FIG. 8 illustrates a side view of the electrohydraulic actuator of FIG. 7, in accordance with an example implementation.

FIG. 9 illustrates a left side view of the electrohydraulic actuator of FIG. 7, in accordance with an example implementation.

FIG. 10 illustrates a right side view of the electrohydraulic actuator of FIG. 7, in accordance with an example implementation.

FIG. 11 illustrates a cross-sectional side view of an integrated pump-manifold assembly, in accordance with an example implementation.

FIG. 12 illustrates a cross-sectional top view of the integrated pump-manifold assembly, in accordance with an example implementation.

FIG. 13 illustrates a cross-sectional side view of the integrated pump-manifold assembly accommodating a pump that is larger than a respective pump shown in FIG. 11, in accordance with an example implementation.

FIG. 14 illustrates a cross-sectional top view of the integrated pump-manifold assembly with the pump of FIG. 13, in accordance with an example implementation.

FIG. 15 illustrates an exploded perspective view of the integrated pump-manifold assembly, in accordance with an example implementation.

FIG. 16 is a flowchart for a method of assembling an integrated pump-manifold assembly, in accordance with an example implementation.

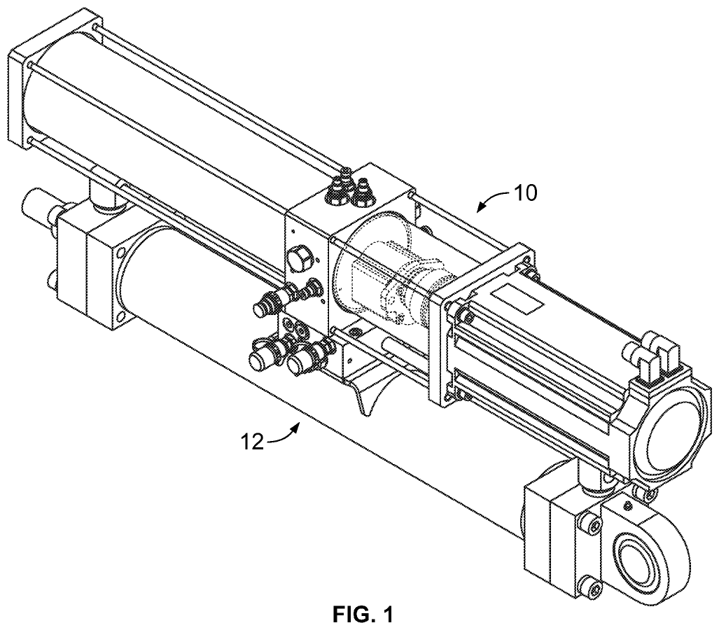

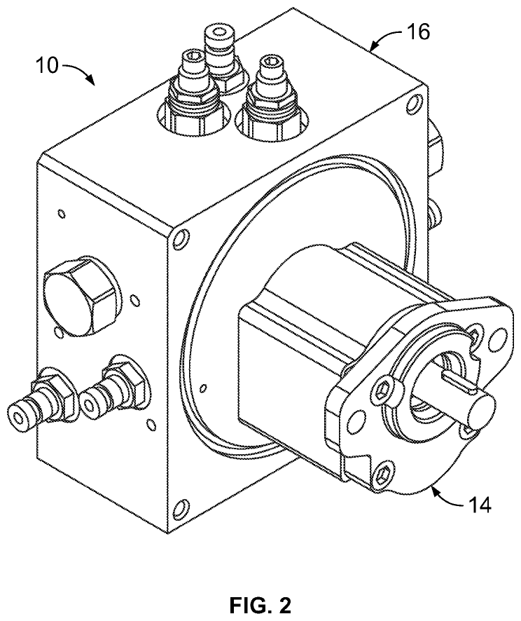

### DETAILED DESCRIPTION

Disclosed herein are systems and assemblies associated with an electro-hydraulic actuator/pump configuration that allows for larger pump inlet/outlet ports without the use of external hoses and fittings. In the disclosed assemblies, a hydraulic pump is integrated inside a manifold, and such integration allows for larger pump inlet/outlet ports in a package that does not change in size as pump displacement changes. Particularly, different size pumps can be integrated into the same manifold without changing the overall size of the assembly.

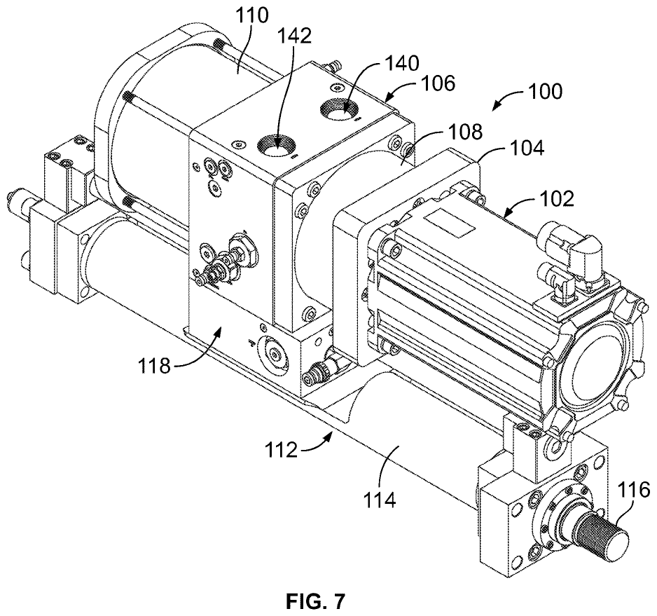

FIG. 7 illustrates a perspective view of an EHA 100, in accordance with an example implementation. The EHA 100 includes an electric motor 102 mounted to a motor plate 104. The electric motor 102 is configured to drive a pump disposed inside an integrated pump-manifold assembly 106. A spacer or shroud 108 can be used to set up a coupling distance between an output shaft of the electric motor 102 and an input shaft of the pump. However, in other examples, the electric motor 102 can be directly coupled to pump, and in these examples, a shroud might not be needed.

The EHA 100 also includes a reservoir 110 mounted to the integrated pump-manifold assembly 106, on an opposite side of the integrated pump-manifold assembly 106 relative to the side to which the electric motor 102 is mounted. The reservoir 110 is configured as a tank containing fluid at a low pressure (e.g., between atmospheric pressure and 70 pounds per square inch). As described below, the pump mounted inside the integrated pump-manifold assembly 106 is configured to draw fluid from the reservoir 110 through an inlet port of the pump, then displace the fluid to an outlet port to be discharged out of the integrated pump-manifold assembly 106.

The EHA 100 further includes a hydraulic cylinder actuator 112 having a cylinder 114 in which a piston 116 is slidably accommodated. The piston 116 can have a piston head that divides an internal space of the cylinder 114 into a first chamber and a second chamber. By providing fluid from the integrated pump-manifold assembly 106 (discharged by the pump) to the first chamber, the piston 116 moves in a first linear direction (e.g., extend), and by providing fluid from the integrated pump-manifold assembly 106 to the second chamber, the piston 116 moves in a second linear direction (e.g., retract), opposite the first linear direction.

In some examples, the EHA 100 can include a load control manifold 118 interposed between the integrated pump-manifold assembly 106 and the hydraulic cylinder actuator 112. The load control manifold 118 can be used to include valves that adapt different types of load control devices. For instance, if the EHA 100 is mounted such that hydraulic cylinder actuator 112 is horizontal and is configured to drive a load coupled to the piston 116 horizontally (without gravity resistance or assistance, e.g., no overrunning loads), the load control manifold 118 can incorporate pilot operated check valves that can lock the piston 116 in position when the electric motor 102 and the pump are not running.

In another example, if the EHA 100 is mounted such that hydraulic cylinder actuator 112 is vertical and is thus configured to be subjected to overrunning loads (e.g., the piston 116 is subjected to a gravity-assisted load), the load control manifold 118 can incorporate counterbalance valves to prevent the load from running away uncontrollably. Thus, different valves can be mounted to the load control manifold 118 depending on the application in which the EHA 100 is used.

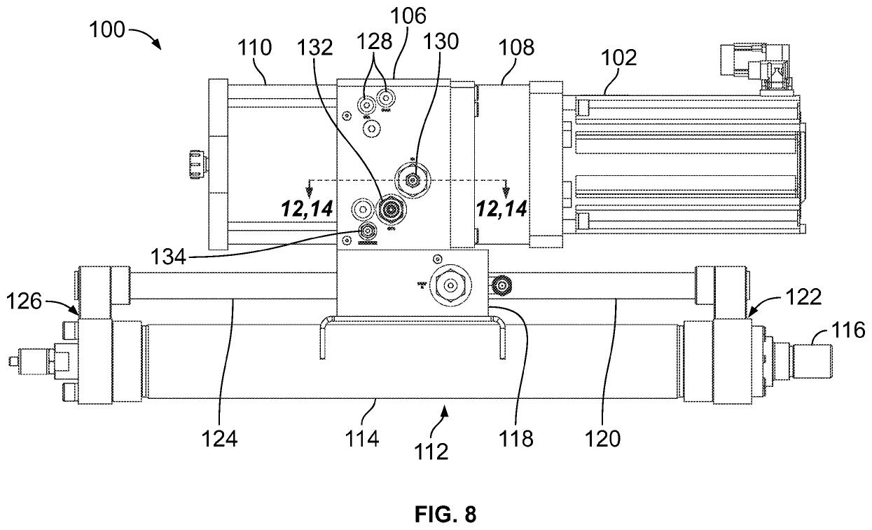

FIG. 8 illustrates a side view of the EHA 100, in accordance with an example implementation. As depicted, the EHA 100 can include a first fluid line 120 (e.g., tube, hose, or pipe) that fluidly couples the load control manifold 118 to a first port 122 of the hydraulic cylinder actuator 112. The first port 122 is configured to provide fluid to and receive fluid from the first chamber inside the cylinder 114, for example.

Similarly, the EHA 100 can include a second fluid line 124 (e.g., tube, hose, or pipe) that fluidly couples the load control manifold 118 to a second port 126 of the hydraulic cylinder actuator 112. The second port 126 is configured to provide fluid to and receive fluid from the second chamber inside the cylinder 114, for example.

With this configuration, to move the piston 116 in one direction, fluid discharged from the integrated pump-manifold assembly 106 flows through the load control manifold 118, then through the first fluid line 120 and the first port 122 to the first chamber inside the cylinder 114. Fluid discharged from the second chamber of the cylinder 114, flows through the second port 126, the second fluid line 124, through the load control manifold 118 to the integrated pump-manifold assembly 106, then to the reservoir 110, for example.

To move the piston 116 in an opposite direction, fluid discharged from the integrated pump-manifold assembly 106 flows through the load control manifold 118, then through the second fluid line 124 and the second port 126 to the second chamber inside the cylinder 114. Fluid discharged from the first chamber of the cylinder 114, flows through the first port 122, the first fluid line 120, through the load control manifold 118 to the integrated pump-manifold assembly 106, then to the reservoir 110, for example.

In other examples, however, the EHA 100 might not include the load control manifold 118. In these examples, the integrated pump-manifold assembly 106 can be directly fluidly coupled to the hydraulic cylinder actuator 112. In some examples, functionality and valves of the load control manifold 118 can be integrated into the integrated pump-manifold assembly 106.

The integrated pump-manifold assembly 106 can include a plurality of ports and valve cavities. For example, the integrated pump-manifold assembly 106 can have cooling fluid ports 128. The cooling ports 128 are used to cool the hydraulic fluid of the EHA 100. For example, a portion of the hydraulic fluid can be diverted from the EHA 100 through one of the cooling ports 128 to a fluid cooler (e.g., a heat exchanger) to cool the fluid. Cooled fluid is then returned to the EHA 100 through the other port of the cooling ports 128, where the fluid passes through a filter and then returned to the reservoir 110.

As described below, the integrated pump-manifold assembly 106 has two ports that can operate as both inlet and outlet ports for the pump disposed within the integrated pump-manifold assembly 106. These ports are disposed laterally in the integrated pump-manifold assembly 106. In some instance, it may be desirable to place diagnostic sensors (e.g., a pressure sensor) to determine the pressure level at such ports. As such, the integrated pump-manifold assembly 106 can have a diagnostic connector 130 in fluid communication with one of the inlet/outlet ports of the pump. The diagnostic connector 130 can have a quick connect coupling that facilitates mounting a pressure sensor thereto, for example.

The integrated pump-manifold assembly 106 can also have a cavity for a pressure relief valve 132. The pressure relief valve 132 is configured to protect one of the inlet/outlet ports of the integrated pump-manifold assembly 106 and the corresponding chamber inside the cylinder 114. If the pressure level in the inlet/outlet port exceeds a threshold value, such as 300 bar or 4350 pounds per square inch (psi), the pressure relief valve 132 opens to relieve such high pressure fluid to the reservoir 110, for example.

The integrated pump-manifold assembly 106 can also include a reservoir port 134. The reservoir port 134 is used to fill the reservoir 110 with hydraulic fluid, for example.

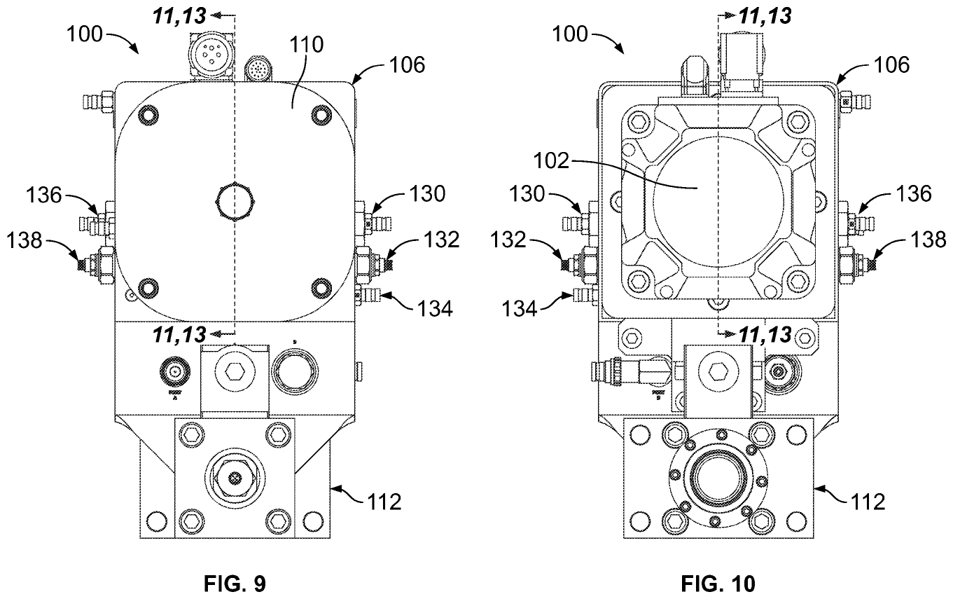

FIG. 9 illustrates a left side view of the EHA 100, and FIG. 10 illustrates a right side view of the EHA 100, in accordance with an example implementation. The integrated pump-manifold assembly 106 has another inlet/outlet port on the other side of the manifold. The integrated pump-manifold assembly 106 can have a diagnostic connector 136 and a pressure relief valve 138 associated with the other inlet/outlet port.

In an example, the pump of the integrated pump-manifold assembly 106 can be configured to operate as a bi-directional pump. Particularly, a first port of the ports of the integrated pump-manifold assembly 106 can operate as an inlet port configured to receive fluid from the reservoir 110, and the second port can operate as an outlet or discharge port for providing fluid being discharged from the pump to the hydraulic cylinder actuator 112. In another mode of operation, the first port can operate as a discharge port for providing fluid being discharged from the pump to the hydraulic cylinder actuator 112, and the second port can operate as an inlet port configured to receive fluid from the reservoir 110.

Referring back to FIG. 7, the integrated pump-manifold assembly 106 can have a cavity for a first pilot operated check valve 140, and a respective cavity for a second pilot operated check valve 142. When the electric motor 102 rotates the input shaft of the pump in a first direction, the pilot operated check valve 140 can be piloted to open to allow fluid flow from the reservoir 110 to the appropriate port of the integrated pump-manifold assembly 106. Similarly, when the electric motor 102 rotates the input shaft of the pump in a second direction, the pilot operated check valve 142 can be piloted to open to allow fluid flow from the reservoir 110 to the respective port of the integrated pump-manifold assembly 106.

The valves, ports, and cavities described above and are example for illustration and are not meant to be limiting. More or fewer ports, cavities, and valves can be used as desired.

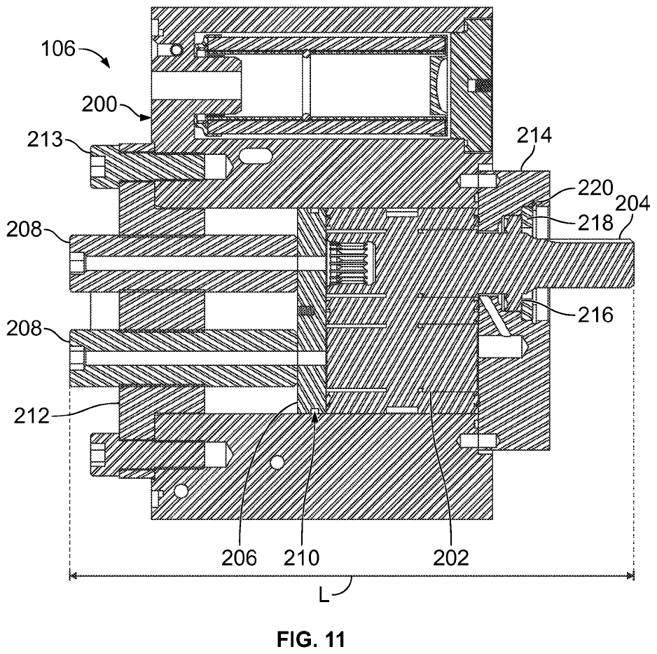

FIG. 11 illustrates a cross-sectional side view of the integrated pump-manifold assembly 106, in accordance with an example implementation. The cutting plane of the cross sectional view shown in FIG. 11 is labelled in FIGS. 9-10.

The integrated pump-manifold assembly 106 has a manifold 200. The manifold 200 is a block with multiple channels, cavities, and ports that enable the flow of hydraulic fluid to and from various hydraulic devices or components. Such block can be made from materials such as steel, aluminum, or brass, for example.

The integrated pump-manifold assembly 106 also has a pump 202 disposed within (mounted into a pump cavity of) the manifold 200. The pump 202 has an input shaft 204 configured to be coupled to an output shaft of the electric motor 102 (e.g., via splines, a key-keyway arrangement, a self-holding taper arrangement, etc.).

The integrated pump-manifold assembly 106 has an adjustable backing plate 206 interfacing with the pump 202. The integrated pump-manifold assembly 106 also has adjustment screws 208 that secure the adjustable backing plate 206 against an end of the pump 202. The adjustable backing plate 206 has a seal 210 (e.g., O-ring) mounted in a groove formed in the adjustable backing plate 206. Particularly, the seal 210 contains the hydraulic pressure generated by the pump 202 within the pump cavity. This way, the seal 210 prevents leakage of fluid from the pump cavity to the reservoir 110.

The integrated pump-manifold assembly 106 has a retaining plate 212 mounted to the manifold 200. For example, the integrated pump-manifold assembly 106 includes socket head cap screws 213 that couple the retaining plate 212 to the manifold 200. The retaining plate 212 is configured to accommodate the adjustment screws 208 therethrough as depicted in FIG. 11.

The integrated pump-manifold assembly 106 further includes a pump face plate 214 mounted to the manifold 200 (e.g., via fasteners such as bolts or screws). As depicted, in an example, the pump face plate 214 is mounted on an opposite side of the manifold 200 relative to the retaining plate 212. The pump face plate 214 supports the input shaft 204 of the pump 202. Particularly, the pump face plate 214 accommodates a shaft seal 216, a spacer 218, and a retainer clip 220 to retain the input shaft 204 of the pump 202 within the pump face plate 214. A portion of the input shaft 204 protrudes outward through the pump face plate 214 to engage with the output shaft of the electric motor 102.

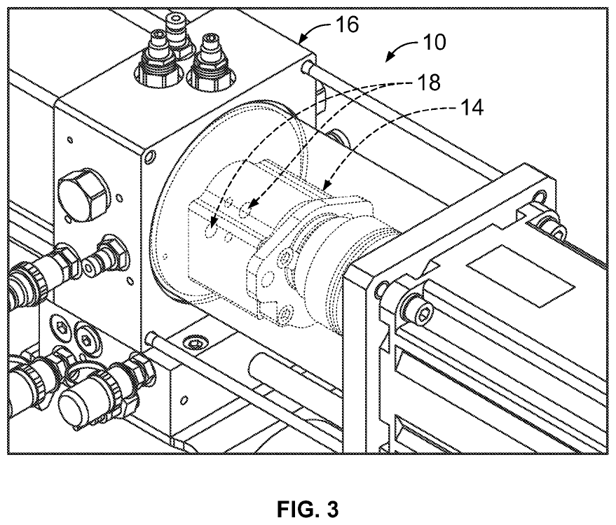

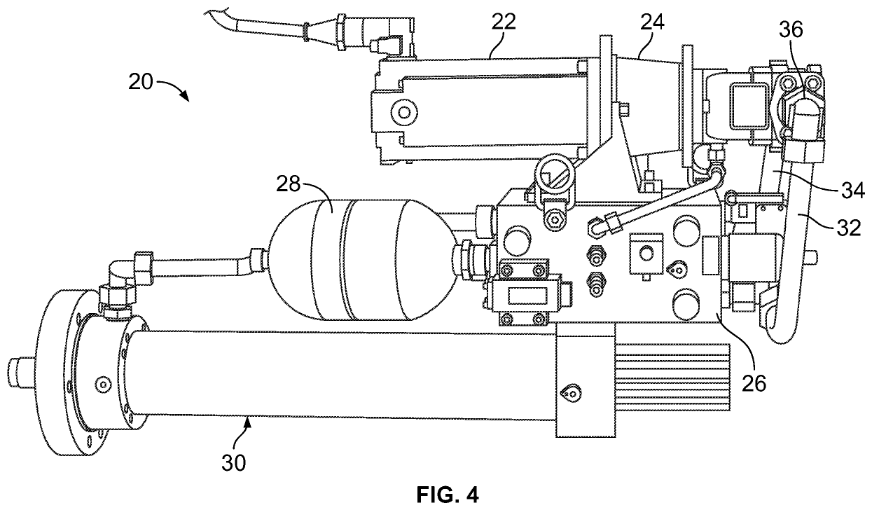

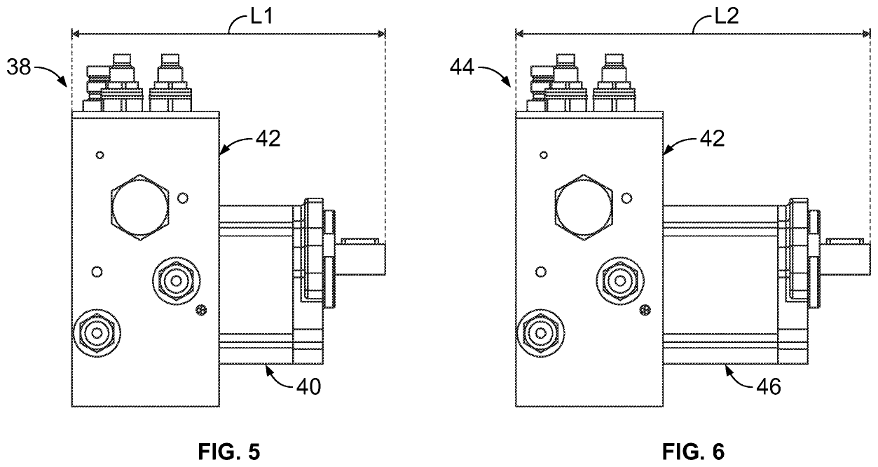

In contrast to conventional pumps wherein the pump ports are in-line with (e.g., at rear or front of the pump as shown in FIG. 3), the pump 202 has inlet/outlet ports formed laterally in the manifold 200. In other words, the inlet/outlet ports are disposed on the sides of the manifold 200 such that fluid provided to the inlet port of the pump and fluid discharged from the outlet port of the pump flows in a direction that is perpendicular to a longitudinal axis of the input shaft 204. This configuration allows for larger pump inlet/outlet ports without the use of external hoses or fittings.

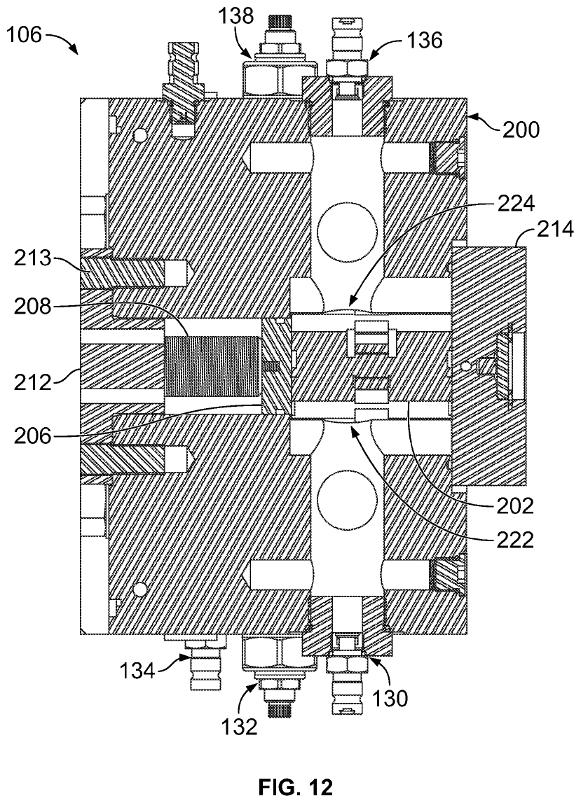

FIG. 12 illustrates a cross-sectional top view of the integrated pump-manifold assembly 106, in accordance with an example implementation. The cutting plane of the cross sectional view shown in FIG. 11 is labelled in FIG. 8.

The manifold 200 has a first port 222 disposed laterally one side of the pump 202 in-line with where the diagnostic connector 130 is mounted. The manifold 200 also has a second port 224 disposed laterally one the other side of the pump 202 in-line with where the diagnostic connector 136 is mounted. The pump 202 is bi-directional and thus each port of the ports 222, 224 can be an inlet or an outlet port, and thus each port is referred to herein as a pump inlet/outlet port.

As the ports 222, 224 are not at the rear or front of the pump 202, their size is not limited by the geometry of the pump 202. Rather, the ports 222, 224 can be made as large as desired. This contrasts with some conventional configurations where a pump housing constrains the size of the pump inlet/outlet ports. As the ports 222, 224 can be made as large as desired, the electric motor 102 can run at high speeds, without causing cavitation at the inlet port of the pump 202.

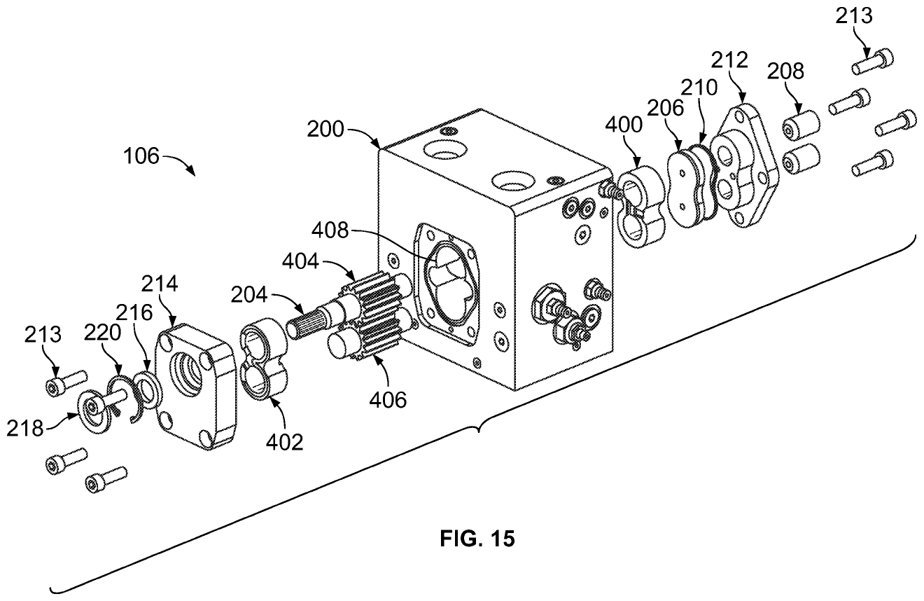

Notably, referring to FIG. 11-12 together, the adjustable backing plate 206 is movable within the pump cavity (see pump cavity 408 in FIG. 15) of the manifold 200 to allow for pumps with various displacements and sizes to be accommodated within the manifold 200 without affecting the size of the integrated pump-manifold assembly 106. Particularly, the adjustable backing plate 206 can be moved within the manifold 200 to a different position to accommodate another pump with a different displacement.

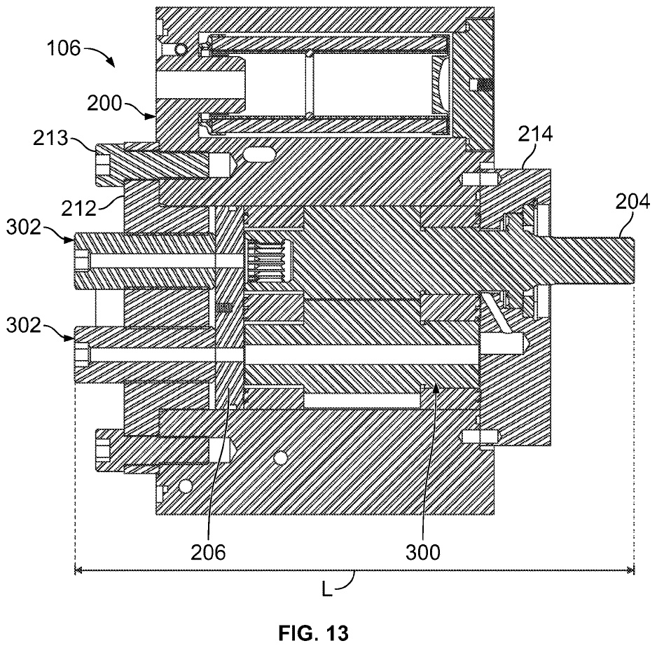

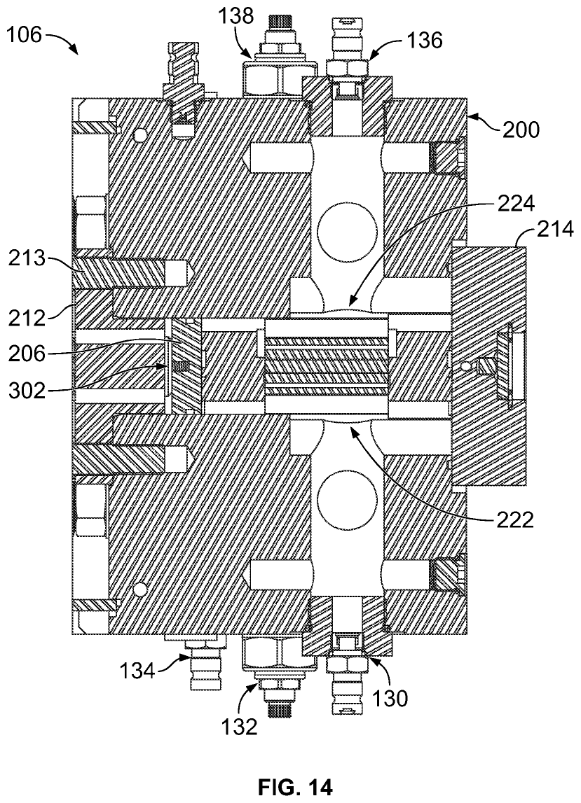

FIG. 13 illustrates a cross-sectional side view of the integrated pump-manifold assembly 106 accommodating a pump 300 that is larger than the pump 202, and FIG. 14 illustrates a cross-sectional top view of the integrated pump-manifold assembly 106 with the pump 300, in accordance with an example implementation. As shown in FIGS. 13-14 compared to FIGS. 11-12, respectively, the pump 300 is larger than the pump 202.

Particularly, the adjustable backing plate 206 has been moved (e.g., to the left in FIGS. 13-14) and shorter adjustment screws 302 are used to allow for a larger space within the manifold 200 to accommodate the pump 300. However, the overall length “L” of the integrated pump-manifold assembly 106 (including the length of the input shaft 204) as labeled in FIGS. 11, 13 remains the same.

As an example for illustration, the pump 202 in FIGS. 11-12 can be a 14 cc pump, whereas the pump 300 in FIGS. 13-14 can be a 52 cc pump, while the overall length L of the integrated pump-manifold assembly 106 remains the same. Thus, various pumps with various displacements and sizes can be accommodated within the manifold 200, while maintaining the overall size of the integrated pump-manifold assembly 106.

Any type of pump can be used as the pump 202, 300. For example, an external gear pump could be used.

FIG. 15 illustrates an exploded perspective view of the integrated pump-manifold assembly 106, in accordance with an example implementation. As shown, the pump 202 can have a first bearing block 400 and a second bearing block 402 that accommodate and support the input shaft 204 that has a pinion 404 mounted thereto or integrated therewith. The bearing blocks 400, 402 also support a driven gear 406 that engages the pinion 404 of the input shaft 204.

The pinion 404 of the input shaft 204 meshes with the driven gear 406. As the pinion 404 and the driven gear 406 rotate, fluid from the inlet port (e.g., one of the ports 222, 224 shown in FIGS. 12, 14) fills the space between corresponding gear teeth and is displaced from the inlet side to the outlet around the external circumference of the gears within a pump cavity 408 in the manifold 200, and fluid is then discharged through the outlet port (the other port of the ports 222, 224). Fluid can then be provided to the hydraulic cylinder actuator 112 as described above.

An external gear pump is used herein as an example for illustration only. However, other types of pumps could be used such as an internal gear pump, a piston pump, a vane pump, a gerotor pump, etc.

Thus, advantageously, the integrated pump-manifold assembly 106 provides a compact solution for EHA/EHP applications. By integrating the pump (e.g., the pump 202, 300) into the manifold 200, higher power outputs can be achieved in a compact package size that is similar or smaller than current EHA/EHP configurations. Particularly, different pump sizes can be accommodated with the same manifold without changing overall package size of an EHA such as the EHA 100.

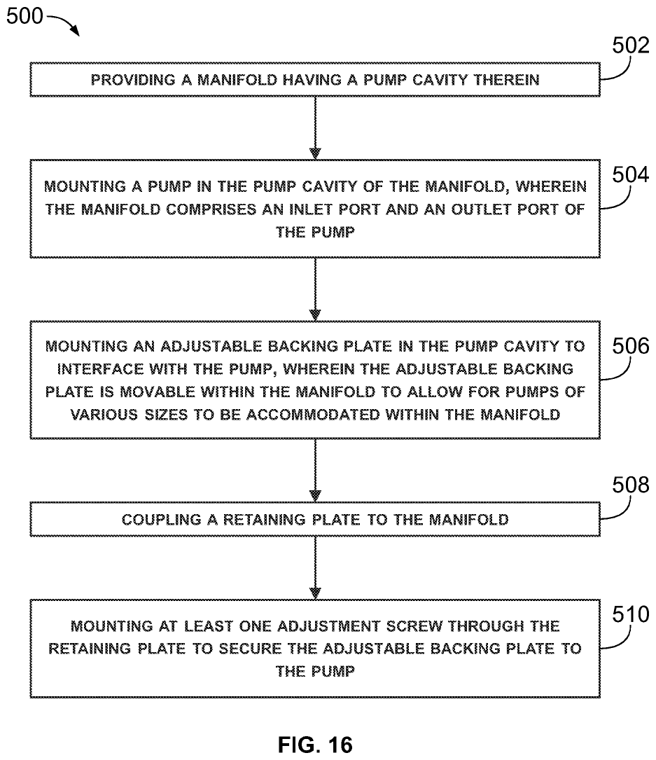

FIG. 16 is a flowchart of a method 500 for assembling the integrated pump-manifold assembly 106, in accordance with an example implementation. The method 500 may include one or more operations, functions, or actions as illustrated by one or more of steps 502-510.

Although the steps are illustrated in a sequential order, these steps may also be performed in parallel, and/or in a different order than those described herein. Also, the various steps may be combined into fewer steps, divided into additional steps, and/or removed based upon the desired implementation. It should be understood that for this and other processes and methods disclosed herein, flowcharts show functionality and operation of one possible implementation of present examples. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 502, the method 500 includes providing the manifold 200 having the pump cavity 408 therein. The term “providing” as used herein, and for example with regard to the manifold 200 or other components, includes any action to make the manifold 200 or any other component available for use, such as bringing the manifold 200 or other components to an apparatus or to a work environment for further processing (e.g., mounting other components, etc.).

At block 504, the method 500 includes mounting the pump 202 in the pump cavity 408 of the manifold 200, wherein the manifold 200 comprises an inlet port (e.g., the first port 222) and an outlet port (e.g., the second port 224) of the pump 202.

At block 506, the method 500 includes mounting the adjustable backing plate 206 in the pump cavity 408 to interface with the pump 202, wherein the adjustable backing plate 206 is movable within the manifold 200 to allow for pumps of various sizes to be accommodated within the manifold 200.

At block 508, the method 500 includes coupling the retaining plate 212 to the manifold 200.

At block 510, the method 500 includes mounting at least one adjustment screw (e.g., at least one of the adjustment screws 208) through the retaining plate 212 to secure the adjustable backing plate 206 to the pump 202.

The method 500 can further include other steps to assemble the integrated pump-manifold assembly 106 as described throughout herein. For example, the method 500 can further include mounting the pump face plate 214 on an opposite side of the manifold 200 relative to the retaining plate 212, wherein the pump face plate 214 supports the input shaft 204 of the pump 202, and wherein the input shaft 204 of the pump 202 protrudes from the pump face plate 214 to facilitate coupling the input shaft 204 to the electric motor 102.

The method 500 can also involve replacing the pump 202 with a larger pump such as the pump 300, For example, the method 500 can further include removing the pump 202 from the manifold 200; moving the adjustable backing plate 206 within the manifold 200; mounting the pump 300 in the pump cavity 408 of the manifold 200, wherein the pump 300 is larger than the pump 202; mounting the shorter adjustment screws 302 (shorter than the adjustment screws 208) through the retaining plate 212 to secure the adjustable backing plate 206 against the pump 300.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

Embodiments of the present disclosure can thus relate to one of the enumerated example embodiment (EEEs) listed below.

EEE 1 is an integrated pump-manifold assembly comprising: a manifold having a pump cavity; a pump disposed in the pump cavity of the manifold, wherein the manifold defines an inlet port and an outlet port of the pump; and an adjustable backing plate disposed within the manifold and secured against the pump, wherein the adjustable backing plate is movable within the manifold to allow for pumps of various displacements to be accommodated within the manifold without affecting a size of the integrated pump-manifold assembly.

EEE 2 is the integrated pump-manifold assembly of EEE 1, further comprising: a plurality of adjustment screws that secure the adjustable backing plate to the pump.

EEE 3 is the integrated pump-manifold assembly of EEE 2, further comprising: a retaining plate mounted to the manifold, wherein the retaining plate accommodates the plurality of adjustment screws securing the adjustable backing plate to the pump.

EEE 4 is the integrated pump-manifold assembly of any of EEEs 1-3, further comprising: a seal mounted in a groove formed in the adjustable backing plate to seal the pump cavity.

EEE 5 The integrated pump-manifold assembly of any of EEEs 1-4, further comprising: a pump face plate mounted to the manifold and configured to support an input shaft of the pump.

EEE 6 is the integrated pump-manifold assembly of EEE 5, wherein the pump face plate accommodates a shaft seal and a retainer clip configured to retain the input shaft of the pump within the pump face plate.

EEE 7 is the integrated pump-manifold assembly of any of EEEs 1-6, wherein the pump is an external gear pump comprising: an input shaft having a pinion integrated therewith and mounted within the pump cavity; a driven gear that engages the pinion of the input shaft; and a first bearing block and a second bearing block mounted within the manifold and configured to support the input shaft and the driven gear.

EEE 8 is the integrated pump-manifold assembly of any of EEEs 1-7, wherein the inlet port and the outlet port are disposed laterally in the manifold relative to a longitudinal axis of an input shaft of the pump.

EEE 9 is an electrohydraulic actuator comprising: a hydraulic cylinder actuator comprising a cylinder and a piston movable within the cylinder; the integrated pump-manifold assembly of any of claims 1-8; an electric motor mounted to the integrated pump-manifold assembly, wherein the electric motor is configured to drive the pump to provide fluid to the cylinder and move the piston; and a reservoir mounted to the integrated pump-manifold assembly and configured as a source of fluid for the pump.

EEE 10 is the electrohydraulic actuator of EEE 9, wherein the electric motor is mounted on a first side of the integrated pump-manifold assembly, and wherein the reservoir is mounted on a second side, opposite the first side, of the integrated pump-manifold assembly.

EEE 11 is the electrohydraulic actuator of any of EEEs 9-10, further comprising: a shroud interposed between the electric motor and the integrated pump-manifold assembly to set up a coupling distance between an output shaft of the electric motor and an input shaft of the pump.

EEE 12 is the electrohydraulic actuator of any of EEEs 9-11, further comprising:
a load control manifold interposed between the integrated pump-manifold assembly and the hydraulic cylinder actuator, wherein the load control manifold comprises one or more valves configured to lock the piston in place or prevent the piston from overrunning when subjected to a gravity-assisted load.

EEE 13 is the electrohydraulic actuator of any of EEEs 9-12, wherein the integrated pump-manifold assembly comprises one or more cooling fluid ports configured to provide hydraulic fluid from the electrohydraulic actuator to a fluid cooler and receive fluid back from the fluid cooler.

As mentioned above, EEE 9 is an electrohydraulic actuator comprising the integrated pump-manifold assembly of any of claims 1-8. For example EEE 14 is the electrohydraulic actuator of any of EEEs 9-13, wherein the integrated pump-manifold assembly further comprises: a plurality of adjustment screws that secure the adjustable backing plate to the pump.

EEE 15 is the electrohydraulic actuator of EEE 14, wherein the integrated pump-manifold assembly further comprises: a retaining plate mounted to the manifold, wherein the retaining plate accommodates the plurality of adjustment screws securing the adjustable backing plate to the pump.

EEE 16 is the electrohydraulic actuator of any of EEEs 9-15, wherein the integrated pump-manifold assembly further comprises: a pump face plate mounted to the manifold and configured to support an input shaft of the pump.

EEE 17 is the electrohydraulic actuator of any of EEEs 9-16, wherein the inlet port and the outlet port are disposed laterally in the manifold relative to a longitudinal axis of an input shaft of the pump.

EEE 18 is a method of assembling the integrated pump-manifold assembly of any of claims of any of EEEs 1-8. For example, the method comprises: providing a manifold having a pump cavity therein; mounting a pump in the pump cavity of the manifold, wherein the manifold comprises an inlet port and an outlet port of the pump; mounting an adjustable backing plate in the pump cavity to interface with the pump, wherein the adjustable backing plate is movable within the manifold to allow for pumps of various sizes to be accommodated within the manifold; coupling a retaining plate to the manifold; and mounting at least one adjustment screw through the retaining plate to secure the adjustable backing plate to the pump.

EEE 19 is the method of EEE 18, further comprising: mounting a pump face plate on an opposite side of the manifold relative to the retaining plate, wherein the pump face plate supports an input shaft of the pump, and wherein the input shaft of the pump protrudes from the pump face plate to facilitate coupling the input shaft to an electric motor.

EEE 20 is the method of any of EEEs 18-19, wherein the pump is a first pump, wherein the at least one adjustment screw is a first adjustment screw, and wherein the method further comprises: removing the first pump from the manifold; moving the adjustable backing plate within the manifold; mounting a second pump in the pump cavity of the manifold, wherein the second pump is larger than the first pump; and mounting a second adjustment screw that is shorter than the first adjustment screw through the retaining plate to secure the adjustable backing plate against the second pump.

What is claimed is:

1. An integrated pump-manifold assembly comprising:
a manifold having a pump cavity;
a pump disposed in the pump cavity of the manifold, wherein the manifold defines an inlet port and an outlet port of the pump; and
an adjustable backing plate disposed within the manifold and secured against the pump, wherein the adjustable backing plate is movable within the manifold to allow for pumps of various displacements to be accommodated within the manifold without affecting a size of the integrated pump-manifold assembly.

2. The integrated pump-manifold assembly of claim 1, further comprising:
a plurality of adjustment screws that secure the adjustable backing plate to the pump.

3. The integrated pump-manifold assembly of claim 2, further comprising:
a retaining plate mounted to the manifold, wherein the retaining plate accommodates the plurality of adjustment screws securing the adjustable backing plate to the pump.

4. The integrated pump-manifold assembly of claim 1, further comprising:
a seal mounted in a groove formed in the adjustable backing plate to seal the pump cavity.

5. The integrated pump-manifold assembly of claim 1, further comprising:
a pump face plate mounted to the manifold and configured to support an input shaft of the pump.

6. The integrated pump-manifold assembly of claim 5, wherein the pump face plate accommodates a shaft seal and a retainer clip configured to retain the input shaft of the pump within the pump face plate.

7. The integrated pump-manifold assembly of claim 1, wherein the pump is an external gear pump comprising:
an input shaft having a pinion integrated therewith and mounted within the pump cavity;
a driven gear that engages the pinion of the input shaft; and
a first bearing block and a second bearing block mounted within the manifold and configured to support the input shaft and the driven gear.

8. The integrated pump-manifold assembly of claim 1, wherein the inlet port and the outlet port are disposed laterally in the manifold relative to a longitudinal axis of an input shaft of the pump.

9. An electrohydraulic actuator comprising:
a hydraulic cylinder actuator comprising a cylinder and a piston movable within the cylinder;
an integrated pump-manifold assembly comprising: (i) a manifold having a pump cavity, (ii) a pump disposed in the pump cavity of the manifold, wherein the manifold defines an inlet port and an outlet port of the pump, and (iii) an adjustable backing plate disposed within the manifold and secured against the pump, wherein the adjustable backing plate is movable within the manifold to allow for pumps of various displacements to be accommodated within the manifold without affecting a size of the integrated pump-manifold assembly;
an electric motor mounted to the integrated pump-manifold assembly, wherein the electric motor is configured to drive the pump to provide fluid to the cylinder and move the piston; and
a reservoir mounted to the integrated pump-manifold assembly and configured as a source of fluid for the pump.

10. The electrohydraulic actuator of claim 9, wherein the electric motor is mounted on a first side of the integrated pump-manifold assembly, and wherein the reservoir is mounted on a second side, opposite the first side, of the integrated pump-manifold assembly.

11. The electrohydraulic actuator of claim 9, further comprising:
a shroud interposed between the electric motor and the integrated pump-manifold assembly to set up a coupling distance between an output shaft of the electric motor and an input shaft of the pump.

12. The electrohydraulic actuator of claim 9, further comprising:
a load control manifold interposed between the integrated pump-manifold assembly and the hydraulic cylinder actuator, wherein the load control manifold comprises one or more valves configured to lock the piston in place or prevent the piston from overrunning when subjected to a gravity-assisted load.

13. The electrohydraulic actuator of claim 9, wherein the integrated pump-manifold assembly comprises one or more cooling fluid ports configured to provide hydraulic fluid from the electrohydraulic actuator to a fluid cooler and receive fluid back from the fluid cooler.

14. The electrohydraulic actuator of claim 9, wherein the integrated pump-manifold assembly further comprises:
a plurality of adjustment screws that secure the adjustable backing plate to the pump.

15. The electrohydraulic actuator of claim 14, wherein the integrated pump-manifold assembly further comprises:
a retaining plate mounted to the manifold, wherein the retaining plate accommodates the plurality of adjustment screws securing the adjustable backing plate to the pump.

16. The electrohydraulic actuator of claim 9, wherein the integrated pump-manifold assembly further comprises:
a pump face plate mounted to the manifold and configured to support an input shaft of the pump.

17. The electrohydraulic actuator of claim 9, wherein the inlet port and the outlet port are disposed laterally in the manifold relative to a longitudinal axis of an input shaft of the pump.

18. A method comprising:
providing a manifold having a pump cavity therein;
mounting a pump in the pump cavity of the manifold, wherein the manifold comprises an inlet port and an outlet port of the pump;
mounting an adjustable backing plate in the pump cavity to interface with the pump, wherein the adjustable backing plate is movable within the manifold to allow for pumps of various sizes to be accommodated within the manifold;
coupling a retaining plate to the manifold; and
mounting at least one adjustment screw through the retaining plate to secure the adjustable backing plate to the pump.

19. The method of claim 18, further comprising:
mounting a pump face plate on an opposite side of the manifold relative to the retaining plate, wherein the pump face plate supports an input shaft of the pump, and wherein the input shaft of the pump protrudes from the pump face plate to facilitate coupling the input shaft to an electric motor.

20. The method of claim 18, wherein the pump is a first pump, wherein the at least one adjustment screw is a first adjustment screw, and wherein the method further comprises:
removing the first pump from the manifold;
moving the adjustable backing plate within the manifold;
mounting a second pump in the pump cavity of the manifold, wherein the second pump is larger than the first pump; and
mounting a second adjustment screw that is shorter than the first adjustment screw through the retaining plate to secure the adjustable backing plate against the second pump.
